(19) United States
(12) Patent Application Publication
(10) Pub. No.: US 2005/0206111 A1
(43) Pub. Date: Sep. 22, 2005

(54) Tunable suspension system for enhanced acceleration characteristics of wheeled vehicles

(76) Inventors: Gregory Ray Gibson, Blue Eye, MO (US); Donald Claude Munson, Blue Eye, MO (US)

Correspondence Address: Gregory R. Gibson, P.O. Box 108, Blue Eye, MO, 65611, US

(21) Appl. No.: 11/058,719

(22) Filed: Feb. 12, 2005

Related U.S. Application Data
(60) Provisional application No. 60/543,669, filed on Feb. 12, 2004.

(51) Int. Cl. B60P 1/00

(52) U.S. Cl. 280/124.104

(57) ABSTRACT

An improved vehicle suspension system providing for readily adjustable rearward weight transfer upon acceleration by permitting controlled upward motion of the mid-wheelbase portion of the vehicle and corresponding dynamic change in center of gravity height. The movement of the central portions of the vehicle in an upward direction is controlled and adjusted through a plurality of pivot points and links, together with variable resistance spring and damper means, to provide for optimum dynamic weight transfer onto driven wheels and superior acceleration characteristics under a variety of road surface, vehicle, and environmental conditions.

### CROSS-REFERENCE TO RELATED APPLICATIONS

The present application claims priority from Applicants' co-pending U.S. provisional application, Ser. No. 60/543,669, filed Feb. 12, 2004.

### STATEMENT REGARDING FEDERALLY SPONSORED RESEARCH OR DEVELOPMENT

Not Applicable.

### BACKGROUND OF THE INVENTION

1. Field of the Invention

This invention relates to a suspension system for a wheeled vehicle.

More particularly, this invention relates to a suspension system allowing controlled and adjustable center of gravity height change upon acceleration, such that a skilled operator may tune or adjust the dynamic weight transfer characteristics exhibited by a vehicle upon rapid acceleration so as to optimize the acceleration of the vehicle under varying vehicle, road surface, and environmental conditions.

2. Description of the Prior Art

Typical front-engined, rear wheel drive drag racing cars have suspension systems derived from the automotive and racing industry which provide enhanced rear tire loading characteristics and adjustability, examples being four-link rear suspensions, ladder bar rear suspensions, and adaptations on leaf spring rear suspensions. Unfortunately, the vehicle dynamics with these systems can be extremely complex with a great number of sometimes conflicting variables (a competition four-link rear suspension might have well over a hundred potential link geometries), such that tuning or “setting up” the vehicle for varying track conditions can be very difficult or impractical under competition conditions. Also, because of their relatively short wheelbase and limited static rear weight distribution, these traditionally suspended cars must often utilize relatively high static center of gravity, such that if the suspension is not balanced precisely the vehicle may lift the front wheels excessively on launch, potentially creating situations which are unsafe and damaging to the vehicle.

Very long wheelbase (180 inch plus), often rear-engined dragsters with solidly mounted front and rear axles were developed in an attempt to eliminate such variables; but while the resulting vehicles certainly have less complexity than traditionally suspended vehicles, they suffer from certain inherent variables of their own. Traditional dragsters utilize their very long wheelbase to increase the static weight distribution on the rear driven tires while resisting excessive rotation of the vehicle about the rear axle centerline for enhanced traction and stability upon rapid acceleration (along with increased polar moment of inertia for greater straight line high speed stability). Such vehicles will also achieve a certain dynamic weight transfer onto the rear tires from acceleration acting upon the center of gravity, which is enhanced by a dynamic center of gravity increase brought about by various factors including an upward bowing of the center portion of the long, somewhat flexible frame. The primary drawbacks of relying upon inherent frame flex to assist rearward weight transfer on launch are that it provides for a very limited adjustability of the total amount of chassis flex or rotational moment about the rear axle centerline (and thus dynamic center of gravity increase and rearward weight transfer); and further the chassis flex is typically undamped, such that the original launch or any subsequent track undulations will set up significant bending oscillations in the chassis which can upset the driven tire loading and the driver's concentration to the detriment of the vehicle's total acceleration capabilities, consistency, and predictability, and could conceivably result in an accident or frame damage.

Some have attempted to place front-engined vehicle derived suspension systems, such as four-link systems, on the rear of dragsters, but while having the last 18 inches or so separately sprung could serve to diminish uncontrolled chassis oscillation by disrupting certain oscillation harmonics, the vast majority of the frame remains an undamped spring such that undesirable and uncontrollable chassis movement is likely to continue; while the extreme long wheelbase and severe mechanical limitations on the ability of the rear axle to move in relation to the rest of the frame dictate that the ability to meaningfully adjust the dynamic center of gravity and rearward weight transfer change is dubious. Others have used frames with unwelded portions, “slip-tubes,” in an attempt to permit greater range of adjustment, but such systems rely solely on friction for partial dampening effect, and achieving consistent and predictable tunability from variations in clamping of tubes, particularly in a competition setting, can be problematic at best.

Inventions such as U.S. Pat. No. 05,630,607 endeavored to increase chassis life of these long dragsters by adding a damped spring to assist in suspending the weight of the center of the vehicle above the ground. This suspension system could have some beneficial effect on dampening down track bumps, but its range of adjustability on what remains very long, relatively flexible frames limits its effectiveness. If the central spring is stiffened so greatly as to be nearly rigid, the device is ineffective and the dragster will behave as any other dragster with uncontrolled oscillation. To the extent the central spring is softened, the vehicle will have oscillations which, while more damped, are potentially of an even greater magnitude than a standard dragster which could lead to the center of the very long wheelbase vehicle bottoming on the ground and generally continued disruption of driven tire loading, the vehicle, and its driver. While upward bowing of the frame and thus change in center of gravity height is possible, the Yancer invention is not designed to readily adjust the dynamic center of gravity height change upon acceleration which is a principal object of our invention. Because of the very long wheelbase (and relatively flexible frames) of the vehicles contemplated in U.S. Pat. No. 05,630,607, the fact that the suspension spring(s) are not oriented to variably resist upward chassis movement, and the damper(s) are not adjustable to varying stiffnesses, significant adjustability of the dynamic center of gravity height and rearward weight transfer change remains poor at best.

A vehicle suspension system which effectively addresses all of the above shortcomings would be highly advantageous. It is a principal object of the invention to provide an improved vehicle suspension system, one which would allow controlled and adjustable center of gravity height change upon acceleration, such that a skilled operator may tune or adjust the dynamic weight transfer characteristics exhibited by a vehicle upon rapid acceleration so as to optimize the acceleration of the vehicle under varying vehicle, road surface, and environmental conditions. It is a further object of the invention to provide such an improved suspension system which would provide these superior and adjustable acceleration characteristics on a vehicle with a relatively short wheelbase and shorter, stiffer frame components in order to be able to avail oneself of other inherent advantages of such shorter vehicles.

### BRIEF SUMMARY OF THE INVENTION

The invention is an improved suspension system for a wheeled vehicle which allows controlled and adjustable center of gravity height change upon acceleration, such that a skilled operator may tune or adjust the dynamic weight transfer characteristics exhibited by a vehicle upon rapid acceleration so as to optimize the acceleration of the vehicle under varying vehicle, road surface, and environmental conditions. The invention utilizes two substantially rigid frame structures (collectively referred to as the chassis), the front connected to one or more front wheels, and the rear connected to one or more driven rear wheels, the two frame structures being connected by fixed pivot points which allow rotation about an axis which is horizontal and perpendicular to the centerline of the vehicle and located relatively near the longitudinal center of gravity and major masses of the vehicle; further having one or more damped springs, with dampening, spring rate, and spring preloading being adjustable, oriented such that the amount and rate of upward rotational moment and upward motion of the central masses of the vehicle on acceleration, and corresponding dynamic change in center of gravity height, are resisted by the spring and dampener to an extent which is quickly and easily adjustable. This invention thus provides for a large range of controlled adjustment of the dynamic center of gravity height, upward chassis rotational moment, and rearward weight transfer, such that the factors such as varying engine output, track surface coefficient of friction, temperature, and climactic conditions can be controlled for in order to obtain the greatest, most predictable, and most consistent acceleration of the vehicle with a minimum of upsetting influences.

The invention also provides ancillary benefits such as highly damped and minimal chassis oscillation with resulting superior down-track traction, driver confidence, and increased chassis life; and the ability of a vehicle designer or builder to mimic longer wheelbase vehicle launch with a shorter wheelbase vehicle with its inherent advantages. Maximum weight transfer to the rear wheels may be attained with less chance of the potentially unsafe and damaging extreme front wheel lift often experienced by shorter wheelbase, traditionally suspended cars, yet with a much greater range of adjustment than ordinarily attainable by long wheelbase dragsters. Although it would be a significant improvement on a long or short wheelbase vehicle, our invention would necessarily have a greater range of adjustability when properly matched to the characteristics and wheelbase of any particular vehicle, e.g. for best results the preferred embodiment for a rear-engined roadster would contemplate a wheelbase of 120 to 150 inches and appropriate static center of gravity height. The orientation of spring resistance of the invention also provides for damped spring assist in returning the vehicle to its desired ride height, which has aerodynamic and stability advantages for most vehicles at higher speeds.

This invention is most suited to vehicles involved in competition, such as drag racing, where the ordinarily smooth track surface minimizes the need for a traditional, passenger car suspension system, yet it is critical to optimize the dynamic weight transfer, center of gravity movement, rotational moment about the rear axle centerline, drive wheel loading, vehicle response time, and other factors often collectively referred to in the industry as the “launch,” under a potential variety of engine output and track surface, temperature, and climactic conditions, in order to obtain the greatest, most predictable, and most consistent acceleration of the vehicle with a minimum of upsetting influences.

### BRIEF DESCRIPTION OF THE SEVERAL VIEWS OF THE DRAWING

FIG. 1 is a side elevation view of a vehicle constructed in accordance with the principles of this invention.

FIG. 2 is a more detailed side elevation view of the suspension system of FIG. 1 illustrating further construction details thereof.

FIG. 3 is a plan view of another embodiment of the suspension system of the invention in which the primary chassis pivot point is above the suspension linkage means.

FIG. 4 is a side elevation view of another embodiment of the suspension system of the invention utilizing multiple links rather than a belcrank to actuate the spring and damper unit.

FIG. 5 is a side elevation view of another embodiment of the suspension system of the invention in which the spring and damper unit serves as the linkage means.

FIG. 6 is a side elevation view of another embodiment of the suspension system of the invention utilizing a torsion bar spring and separate damper unit.

### DETAILED DESCRIPTION OF THE PREFERRED EMBODIMENTS

The invention is an improved suspension system for a wheeled vehicle which allows controlled and adjustable center of gravity height change upon acceleration, such that a skilled operator may tune or adjust the dynamic weight transfer characteristics exhibited by a vehicle upon rapid acceleration so as to optimize the acceleration of the vehicle under varying vehicle, road surface, and environmental conditions. The invention utilizes two substantially rigid frame structures (collectively referred to as the vehicle frame), the front connected to one or more front wheels, and the rear connected solidly to one or more driven rear wheels, the two frame structures being connected by fixed pivot points which allow rotation about an axis which is horizontal and perpendicular to the centerline of the vehicle and located relatively near the longitudinal center of gravity and major masses of the vehicle; further having one or more damped springs, with dampening, spring rate, and spring preloading being adjustable, oriented such that the amount and rate of upward rotational moment and upward motion of the central masses of the vehicle on acceleration, and corresponding dynamic change in center of gravity height, are resisted by the spring and dampener to an extent which is quickly and easily adjustable.

This is an improvement over existing arrangements, as discussed in the Background above, because of its ability to provide a much larger range of rear-tire dynamic loading and launching characteristics than presently attainable with most long wheelbase vehicles, with the equally important attribute that said adjustments can be more quickly and easily made, with a great deal of predictability, in a competition environment presently available to long or short wheelbase vehicles. Also, the orientation of spring forces tends to assist in returning the vehicle to its at rest ride height in a controllable way, which is beneficial for aerodynamic and stability reasons, far more so than any present design. Further, in high power-to-weight ratio vehicles, such as drag racing vehicles, the forces acting to lift all portions of the vehicle forward of the rear driven wheels (except for the extreme front at higher speeds with customary aerodynamic devices) tend to be larger than the force of gravity for most if not all of the period of acceleration, this invention is better able to control those forces than any present design because of the primary spring orientation. Finally, because of the predominance of the time the vehicle is “on the spring” during an acceleration run, and because the invention embodies a separate, much stiffer dampened springing medium for preventing the center of the vehicle from deflecting downward further than desired, and the invention allows for a significantly shorter wheelbase and stiffer frame structures while still controlling rear tire loading ability, significant frame oscillation is prevented and other benefits of a shorter wheelbase vehicle can be realized.

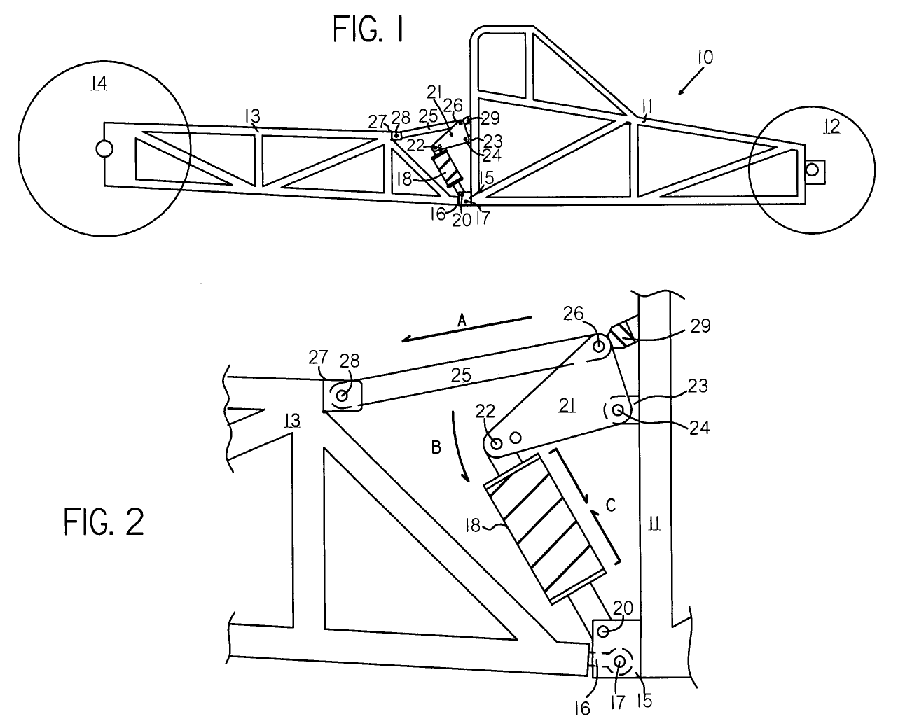

Optimizing the positive attributes of the invention may be aided by a vehicle with certain characteristics, and therefore the preferred embodiments illustrated and described herein are for the purpose of illustration and recommended for best results and broadest range of tunability, but not by way of limitation of either embodiments of the invention or applications with respect to vehicles with less optimal characteristics. FIG. 1 and FIG. 2 illustrate a rear engined drag racing vehicle 10 equipped with a suspension system constructed in accordance with the principles of the invention. The vehicle includes a substantially rigid front frame structure 11 onto the front portion of which is mounted at least one wheel 12 upon which the front of the vehicle may rest without the frame touching the ground. This forward frame structure 11 would typically be constructed of steel, aluminum, composite materials, or other structural materials providing a structure sufficiently rigid to accept anticipated torsional and bending loads with minimal deflection, and in this embodiment said portion would house the major masses of the driver and protective cage. The vehicle includes a substantially rigid rear frame structure 13 onto the rear portion of which is mounted at least one driven wheel 14 upon which the rear of the vehicle may rest without the frame touching the ground, the rear axle housing being solidly mounted to the rear frame structure for best results. The rear frame structure 13 would also typically be constructed of steel, aluminum, composite materials, or other structural materials providing a structure sufficiently rigid to accept anticipated torsional and bending loads with minimal deflection, and in this embodiment said portion would enclose the major masses of the motor, transmission, differential, and ancillary components. It should be noted that while certain of the major masses of the vehicle could be housed in the front or rear frame structure without falling outside the scope of this invention, this invention specifically contemplates a rear wheel drive vehicle, and would not be suitable or effective for a front wheel drive vehicle.

In order to allow the mid-wheelbase portion of the vehicle, and accordingly the major masses, to rotate about their respective front or rear wheel centerline and raise the center of the vehicle and thus center of gravity height, the invention contemplates connecting the front and rear structures with connecting means which allow relative rotation about an axis which is horizontal and perpendicular to the vehicle centerline. In the preferred embodiment, the axis around which the front structure 11 and rear structure 13 are allowed to rotate relative to each other would be at the lower point at which the structures meet, although substantially similar results could be obtained by differently placed pivot points as in FIG. 3. Accordingly, FIG. 1 and FIG. 2 show the preferred construction, in which the lower, rearward portion of the front frame structure 11 is fashioned with brackets 15 to locate the pivot points 17 for the frame structures. The lower, forward portion of the rear frame structure 13 is constructed with rod ends or similar attachment devices 16 which may be pivotally attached to the brackets 15 by bolts or pins so as to locate the frames with the single freedom of movement being axial rotation of the front or rear frame structures about the pivot point 17.

A linkage means connects the front structure 11 and rear structure 13 so as to restrict axial rotation of the frames in order that they do not rotate downward into the ground, or rotate upward and away from each other except as controlled by the spring and damper means. In the preferred embodiment illustrated in FIG. 1 and FIG. 2, to the rear of the front structure 11 is fixedly attached one or more brackets 23 locating a pivot point 24, and to the forward portion of the rear structure is fixedly attached one or more brackets 27 locating another pivot point 28. The forces imparted upon the vehicle on acceleration tend to cause the rear frame structure 13 to rotate upwards about the rear axle centerline, such that the rearward portion of the front frame structure 11 is also lifted and the upper portions of the two frame structures tend to separate if unabated; further, gravity acts upon the mid-wheelbase portion of the vehicle tending to cause downward rotation. Accordingly a linkage means comprising pullrod link 25 is pivotally attached to pivot point 28 with a bolt or pin, its other end being a third pivot point 26. A triangularly shaped belcrank 21 is pivotally attached to the second pivot point 24 with a bolt or pin, and is pivotally attached to the third pivot point 26 by a bolt or pin. A fourth pivot point located by the belcrank 22 is pivotally attached to one end of the spring and damper means, here comprising an automotive coil spring with adjustable seat pad and 7. automotive damper with a minimum of easily accessible adjustments for motion resistance, commonly known in the industry as an “adjustable coil-over” unit 18. The other end of the adjustable coil-over comprises a pivot point 20, which is pivotally located onto the vehicle frame, in these illustrations with a bolt or pin fixedly attached to bracket 15. At the rest, the desired minimum ground clearance is maintained by contact of the linkage means with a bump stop 29 of a hard rubber or similar firm springing medium fixedly attached to the upper rear portion of the front frame structure 11.

In the embodiment of FIG. 1 and FIG. 2, the linkage means and spring and damper means are oriented so that the coil-over unit 18 will be compressed as the frame structures separate on acceleration, which is generally preferred because coil-over units designed to accept compressive loads are far more available, though the linkage means could be attached and oriented differently such that the spring would be loaded in tension under vehicle acceleration. The preferred embodiment utilizes what is known in the industry as a pullrod/pushrod and belcrank assembly, because this configuration provides direct load paths, eliminates the bending compliance which is found in most rocker configurations, the pivot points and component orientation can be modified to meet a wide array of vehicle design and packaging requirements, and it allows a further capacity for altering belcrank pivot points to adjust the spring/damper rate curves and would typically be installed with a greater than 1:1 motion ratio allowing the spring and damper unit to provide finer adjustment on even quite small frame motions.

As illustrated in FIG. 1 and FIG. 2, under forward acceleration forces, the mid-wheelbase portion of the vehicle chassis will tend to rise, causing the upper portion of the rear frame structure to separate from the upper portion of the front structure. This relative movement causes the rear frame to pull the pullrod 25, as indicated by arrow A, which will rotate the belcrank 21 in the direction indicated by arrow B, which compresses spring and damper of the coil-over unit 18, per arrow C, said action thus being resisted to a knowable and adjustable degree. At rest, or when minimal or negative acceleration forces are being applied to the vehicle, it will rest on the bump-stop 29 at the desired ride height. Because accelerative forces will be acting on the linkage means at most relevant times such that the vehicle is “on the spring” and not resting on the bump stop, and because anticipated racing surfaces are ordinarily quite smooth, and because common low ground clearances and aerodynamic forces dictate that the ability to maintain a minimum ground clearance is more critical than having the center masses sprung against gravity, such that coupled with the superior control and adjustability of the dynamic center of gravity, the invention represents an improvement over existing suspension systems for its intended purpose.

The remaining drawings illustrate further embodiments of how the invention may be altered in its layout, installation, or the like, as may be desired by the builder or required by differing vehicle design or packaging requirements. First, it should be noted that the invention also contemplates the design as drawn in FIG. 1 and FIG. 2 comprised of more than one linkage means and spring and damper means. As vehicle balance would tend to dictate, such a multiple coil-over design would most likely comprise substantially identical linkage means and spring and damper means one to another, with attachment and pivot points the same in side elevation view, such that the drawings and discussion herein, may also be used to understand a plural arrangement of any of the embodiments described herein.

In FIG. 3, the vehicle pivot points have been inverted to illustrate that the invention may be embodied differently as may be desired for vehicle packaging and design requirements. In the embodiment illustrated in FIG. 3, each of the numbered components are as set out in FIG. 1 and FIG. 2 above, except that in this embodiment, accelerative forces acting upward will tend to cause the distance between the lower portions of the front and rear frame structures to decrease, and thus would resolve as a tensile force upon the spring and damper means. As discussed, the pullrod and belcrank assembly could be re-arranged such that accelerative forces resolved as compressive force on the spring and damper means.

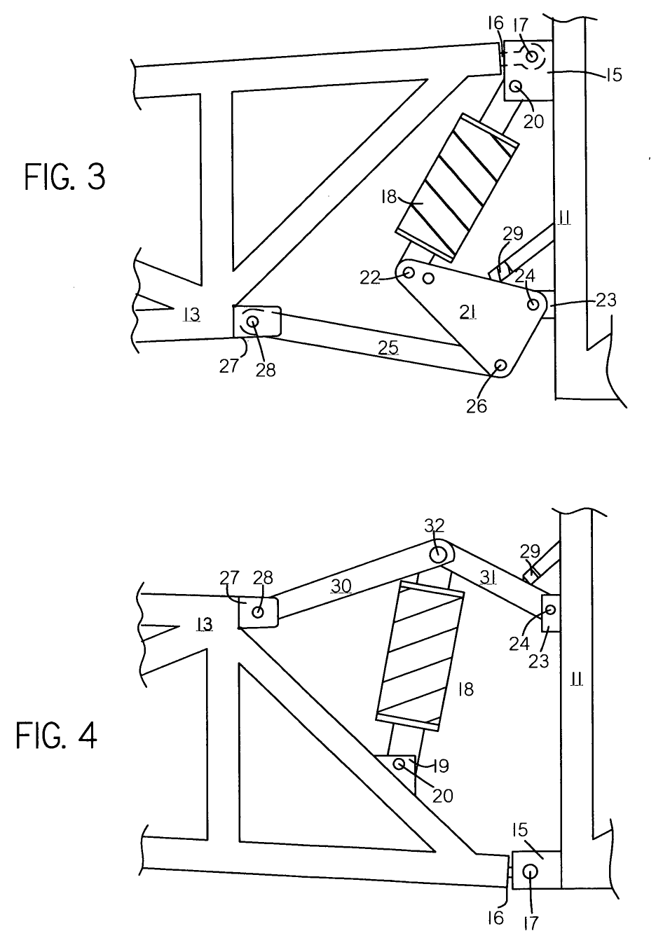

Another embodiment of the invention is illustrated in FIG. 4, wherein a plurality of links are utilized in lieu of a pullrod and belcrank system. Here, the front frame structure 11 and rear frame structure 13 remain pivotally connected about primary pivot point 17 by a bolt or pin through the bracket 15 and rod end 16. However, the linkage means is comprised of a rear link 30 pivotally connected to the rear pivot point 28 by being pinned or bolted to bracket 27, and a forward link 31 pivotally connected to the forward pivot point 24 by being bolted or pinned to bracket 23. The links 30 and 31 are pivotally connected to each other and one end of the spring and damper unit 18 at a third pivot point 32 by a bolt or pin. The lower end of the coil-over 18 is pivotally attached to the frame via a bracket 19 with a bolt or pin at pivot point 20. When not under acceleration loads, the link 31 rests against bump stop 29. Acceleration forces and upward movement of the mid-wheelbase portion of the vehicle are resolved as relative downward movement of the third pivot point 32, and thus compressing the spring and damper means 18. Once again, alternative linkage layouts could be employed, so long as acceleration forces and upward movement of the mid-wheelbase portion of the vehicle resolve into force applied to the spring and damper means.

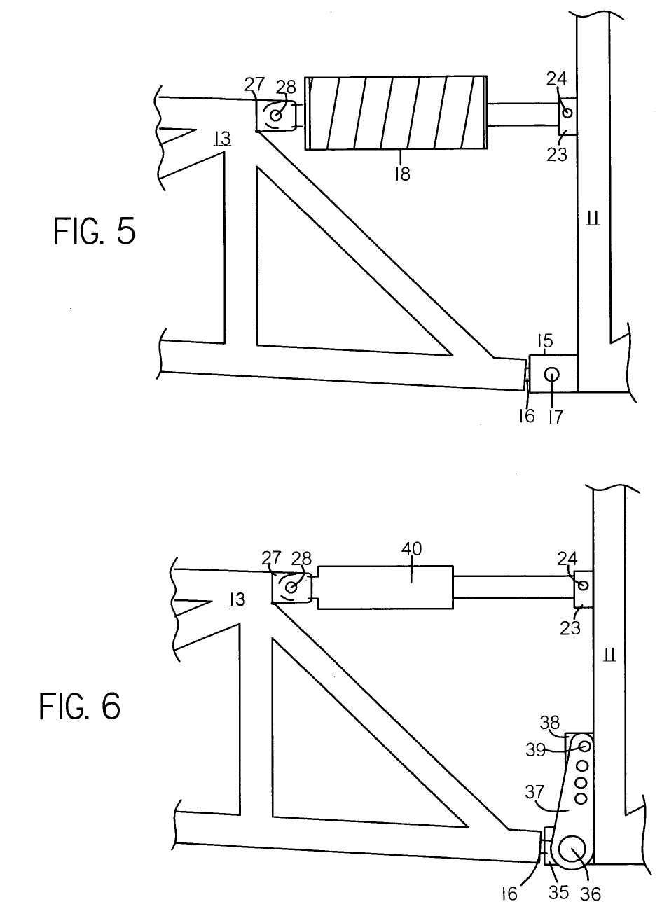

Another embodiment of the invention is illustrated in FIG. 5, wherein the linkage means is effectively simplified to be comprised only of the spring and damper means. Here, the front frame structure 11 and rear frame structure 13 remain pivotally connected about primary pivot point 17 by a bolt or pin through the bracket 15 and rod end 16. However, the linkage means is comprised of one end of the spring and damper unit 18 being pivotally connected to the rear pivot point 28 by being pinned or bolted to bracket 27, and the other end of the spring and damper unit being pivotally connected to the forward pivot point 24 by being bolted or pinned to bracket 23. The bump stop would be a rubber stop between the main body of the damper and the spring mount located on the free portion of the damper. When not under acceleration loads, the central weight of the vehicle rests on said bump stop. Acceleration forces and upward movement of the mid-wheelbase portion of the vehicle are resolved as separation of front and rear pivot points 24 and 28, and thus imparting a tensile load on the spring and damper means 18. Once again, alternative pivot layouts could be employed, so long as acceleration forces and upward movement of the mid-wheelbase portion of the vehicle resolve into force applied to the spring and damper means.

Another embodiment of the invention is illustrated in FIG. 6, wherein the linkage means is effectively simplified to be comprised only of a damper, and a separate tension bar spring means is utilized. Here, the front frame structure 11 and rear frame structure 13 remain pivotally connected about a primary pivot point 36, which in this embodiment is comprised of a torsion bar housing and bracket 35 which is fixedly attached to the front frame structure 11. The rear frame structure 13 is fixedly attached to ends of torsion bars running along the primary pivot axis 36 through ends 16. the other ends of the torsion bar(s) are fixedly attached to levers 37, which are in turn pivotally attached to bracket 38 at pivot point 39 by a bolt or pin, said bracket 38 being fixedly attached to frame 11. Thus, relative rotation of the front and rear frames around the primary pivot point 36 resolves in application of torsion to the torsion bar levers, which it is anticipated would be provided with multiple pivot points such that varying degrees of stiffness could be achieved.

In this embodiment, the linkage means is comprised of one end of the damper unit 40 being pivotally connected to the rear pivot point 28 by being pinned or bolted to bracket 27, and the other end of the damper unit being pivotally connected to the forward pivot point 24 by being bolted or pinned to bracket 23. The bump stop would be a rubber stop between the main body of the damper and the dust cover located on the free portion of the damper. When not under acceleration loads, the central weight of the vehicle rests on said bump stop. Acceleration forces and upward movement of the mid-wheelbase portion of the vehicle are resolved as separation of front and rear pivot points 24 and 28, and thus imparting a torsion load on the spring which is damped by the damper. Once again, multiple spring and/or damper units or alternative pivot layouts could be employed, so long as acceleration forces and upward movement of the mid-wheelbase portion of the vehicle resolve into force applied to the spring and damper means.

These illustrated embodiments of the invention are not intended to be exclusive or limiting, but serve only as examples of how the invention may be varied while accomplishing its purpose of providing readily adjustable dynamic center of gravity height and rotational moment, and therefore a tunable launch, which a skilled operator may utilize to optimize the vehicle's acceleration characteristics to varying conditions in a competition environment. The invention also provides ancillary benefits such as highly damped and minimal unwanted chassis oscillation with resulting superior down-track traction and driver confidence and increased chassis life. Although it would be a significant improvement on a long or short wheelbase vehicle, our invention would necessarily have a greater range of adjustability on a shorter wheelbase vehicle. Furthermore, it is easier to maintain frame stiffness when shorter, such that any frame movement other than that allowed and controlled by the suspension system is minimized, making predictable tuning simpler. Thus for best results the preferred embodiment would contemplate a wheelbase of 120 to 150 inches and a static center of gravity height low enough to provide the greatest range of adjustment for the given vehicle specifications. The orientation of spring resistance of the invention also provides for damped spring assist in returning the vehicle to its desired ride height, which has aerodynamic and stability advantages for most vehicles at higher speeds.

1. In combination with a vehicle frame, said frame including:
a front structure spaced above the ground and including at least one ground engaging wheel mounted on the forward, outer portion of said front structure, and
a rear structure spaced above the ground and including at least one ground engaging, driven wheel mounted on the rearward, outer portion of said rear structure;
the improvements comprising suspension means to allow for variable and controlled raising of the central portion of the vehicle frame and accordingly the center of gravity thereof upon acceleration of the vehicle, said suspension means including:
(a) means for the forward portion of the rear structure to connect to the rear portion of the front structure by at least one primary pivot point such that the front and rear structures can each pivot about its respective axle centerline and pivot with respect to each other about an axis passing horizontally through the pivot point(s) and perpendicular to the longitudinal centerline of the car; and
(b) linkage means for pivotally interconnecting one or more rear pivot point(s) on the forward portion of said rear structure with one or more forward pivot point(s) on the rear portion of said front structure, said linkage means including a plurality of links pivotally interconnecting said forward and rear pivot points, said linkage means controlling the aforesaid rotational freedom of movement of the front and rear structures, thereby
(i) preventing significant downward displacement of the mid-wheelbase portion of said vehicle, such that the desired minimum ground clearance of said vehicle is maintained under all normal operational conditions, while
(ii) permitting the mid-wheelbase portion of said vehicle frame to be upwardly displaced away from the ground, and thus the distance between said forward and rear pivot points to increase or decrease, when the vehicle is acted upon by accelerative and rotational forces transferred by the rear drive wheel(s); and
(c) one or more resilient, adjustable spring and adjustable damper means, including one end pivotally connected to said vehicle frame and a second end pivotally connected to said linkage means, with said spring and damper means attached so that they respectively resist and damp said accelerative and rotational forces and said tendency for the central portion of said vehicle frame to rise upon vehicle acceleration, thus
(i) limiting the maximum amount of upward displacement of said mid-wheelbase portion of the vehicle upon acceleration, and the resultant dynamic rise of vehicle center of gravity height, to an extent which may be adjusted and modified in order to optimize upward center of gravity height change and resultant rearward weight transfer for desired acceleration characteristics,
(ii) controlling the rate at which said upward displacement of said mid-wheelbase portion of the vehicle occurs upon acceleration, to an extent which may be adjusted and modified in order to optimize upward center of gravity height change and resultant rearward weight transfer for desired acceleration characteristics,
(iii) providing an adjustable and damped spring resilient force to assist the return of said mid-wheelbase portion of the vehicle to its at-rest position, and
(iv) providing an adjustable degree of damping of all of said upward or downward relative motions of said mid-wheelbase portion of the vehicle which might occur during vehicle operation.

2. The combination of claim 1 wherein said linkage means limits downward motion of said mid-wheelbase portion of said vehicle below the design minimum ground clearance by means comprising contact by one or more of the components of the linkage means or spring and damper means with a hard rubber or similar minimally compliant bump stop so as to prevent movement beyond the desired range of motion.

3. The combination of claim 1 wherein the said primary pivot means is located below the linkage means attachments, and the location of the linkage means attachments and spring and damper means attachments are arranged such that a compressive force is generated on said resilient spring and damper means when the vehicle is acted upon by accelerative and rotational forces transferred by the rear drive wheel(s) and the mid-wheelbase portion of said vehicle frame is upwardly displaced away from the ground, with the resultant change in the distance between said front and rear frame structures.

4. The combination of claim 1 wherein the said primary pivot means is located below the linkage means attachments, and the location of the linkage means attachments and spring and damper means attachments are arranged such that a tensile force is generated on said resilient spring and damper means when the vehicle is acted upon by accelerative and rotational forces transferred by the rear drive wheel(s) and the mid-wheelbase portion of said vehicle frame is upwardly displaced away from the ground, with the resultant change in the distance between said front and rear frame structures.

5. The combination of claim 1 wherein the said primary pivot means is located above the linkage means attachments, and the location of the linkage means attachments and spring and damper means attachments are arranged such that a compressive force is generated on said resilient spring and damper means when the vehicle is acted upon by accelerative and rotational forces transferred by the rear drive wheel(s) and the mid-wheelbase portion of said vehicle frame is upwardly displaced away from the ground, with the resultant change in the distance between said front and rear frame structures.

6. The combination of claim 1 wherein the said primary pivot means is located above the linkage means attachments, and the location of the linkage means attachments and spring and damper means attachments are arranged such that a tensile force is generated on said resilient spring and damper means when the vehicle is acted upon by accelerative and rotational forces transferred by the rear drive wheel(s) and the mid-wheelbase portion of said vehicle frame is upwardly displaced away from the ground, with the resultant change in the distance between said front and rear frame structures.

7. The combination of claim 1 wherein the linkage means comprises multiple, parallel linkage means and the spring and damper means comprise multiple, parallel spring and damper means, such that each of the multiple linkage means and spring and damper means are acted upon by the forces acting upon the vehicle.

8. The combination of claim 1 wherein the linkage means comprises one or more pullrod and belcrank(s), such that upward displacement of the mid-wheelbase portion of said vehicle frame is converted into motion of the pivotal attachment of the spring and damper means such that a tensile force is generated on said resilient spring and damper means when the vehicle is acted upon by accelerative and rotational forces transferred by the rear drive wheel(s).

9. The combination of claim 1 wherein the linkage means comprises one or more pullrod and belcrank(s), such that upward displacement of the mid-wheelbase portion of said vehicle frame is converted into motion of the pivotal attachment of the spring and damper means such that a compressive force is generated on said resilient spring and damper means when the vehicle is acted upon by accelerative and rotational forces transferred by the rear drive wheel(s).

10. The combination of claim 1 wherein the linkage means comprises a plurality of links,
(a) at least one of which links is pivotally connected to said forward pivot point(s) and
(b) at least one of which links is pivotally connected to said rear pivot point(s) and
(c) said front and rear links pivotally connected to each other, such that upward displacement of the mid-wheelbase portion of said vehicle frame is converted into motion of the third pivot point thereby created, said third pivot point being pivotally attached, directly or via further links, to the pivotal attachment of the spring and damper means
such that a compressive force is generated on said resilient spring and damper means when the vehicle is acted upon by accelerative and rotational forces transferred by the rear drive wheel(s).

11. The combination of claim 1 wherein the linkage means comprises a plurality of links,
(a) at least one of which links is pivotally connected to said forward pivot point(s) and
(b) at least one of which links is pivotally connected to said rear pivot point(s) and
(c) said front and rear links pivotally connected to each other, such that upward displacement of the mid-wheelbase portion of said vehicle frame is converted into motion of the third pivot point thereby created, said third pivot point being pivotally attached, directly or via further links, to the pivotal attachment of the spring and damper means
such that a tensile force is generated on said resilient spring and damper means when the vehicle is acted upon by accelerative and rotational forces transferred by the rear drive wheel(s).

12. In combination with a vehicle frame, said frame including:
a front structure spaced above the ground and including at least one ground engaging wheel mounted on the forward, outer portion of said front structure, and
a rear structure spaced above the ground and including at least one ground engaging, driven wheel mounted on the rearward, outer portion of said rear structure;
the improvements comprising suspension means to allow for variable and controlled raising of the central portion of the vehicle frame and accordingly the center of gravity thereof upon acceleration of the vehicle, said suspension means including:
(a) means for the forward portion of the rear structure to connect to the rear portion of the front structure by at least one primary pivot point such that the front and rear structures can each pivot about its respective axle centerline and pivot with respect to each other about an axis passing horizontally through the pivot point(s) and perpendicular to the longitudinal centerline of the car; and
(b) linkage means for pivotally interconnecting one or more rear pivot point(s) on the forward portion of said rear structure with one or more forward pivot point(s) on the rear portion of said front structure, said linkage means comprising one or more spring and damper means pivotally interconnecting said forward and rear pivot points, said linkage means controlling the aforesaid rotational freedom of movement of the front and rear structures, thereby
(i) preventing significant downward displacement of the mid-wheelbase portion of said vehicle, such that the desired minimum ground clearance of said vehicle is maintained under all normal operational conditions, while
(ii) permitting the mid-wheelbase portion of said vehicle frame to be upwardly displaced away from the ground, and thus the distance between said forward and rear pivot points to increase or decrease, when the vehicle is acted upon by accelerative and rotational forces transferred by the rear drive wheel(s); and
(c) with said spring and damper means attached so that they respectively resist and damp said accelerative and rotational forces and said tendency for the central portion of said vehicle frame to rise upon vehicle acceleration, thus
(i) limiting the maximum amount of upward displacement of said mid-wheelbase portion of the vehicle upon acceleration, and the resultant dynamic rise of vehicle center of gravity height, to an extent which may be adjusted and modified in order to optimize upward center of gravity height change and resultant rearward weight transfer for desired acceleration characteristics,
(ii) controlling the rate at which said upward displacement of said mid-wheelbase portion of the vehicle occurs upon acceleration, to an extent which may be adjusted and modified in order to optimize upward center of gravity height change and resultant rearward weight transfer for desired acceleration characteristics,
(iii) providing an adjustable and damped spring resilient force to assist the return of said mid-wheelbase portion of the vehicle to its at-rest position, and
(iv) providing an adjustable degree of damping of all of said upward or downward relative motions of said mid-wheelbase portion of the vehicle which might occur during vehicle operation.

13. The combination of claim 12 wherein said linkage means limits downward motion of said mid-wheelbase portion of said vehicle below the design minimum ground clearance by means comprising contact by one or more of the components of the linkage means or spring and damper means with a hard rubber or similar minimally compliant bump stop so as to prevent movement beyond the desired range of motion.

14. The combination of claim 12 wherein the said primary pivot means is located below the linkage means attachments, and the location of the spring and damper means attachments are such that a tensile force is generated on said resilient spring and damper means when the vehicle is acted upon by accelerative and rotational forces transferred by the rear drive wheel(s) and the mid-wheelbase portion of said vehicle frame is upwardly displaced away from the ground, with the resultant change in the distance between said front and rear frame structures.

15. The combination of claim 12 wherein the said primary pivot means is located above the linkage means attachments, and the location of the spring and damper means attachments are such that a compressive force is generated on said resilient spring and damper means when the vehicle is acted upon by accelerative and rotational forces transferred by the rear drive wheel(s) and the mid-wheelbase portion of said vehicle frame is upwardly displaced away from the ground, with the resultant change in the distance between said front and rear frame structures.

16. In combination with a vehicle frame, said frame including:
a front structure spaced above the ground and including at least one ground engaging wheel mounted on the forward, outer portion of said front structure, and
a rear structure spaced above the ground and including at least one ground engaging, driven wheel mounted on the rearward, outer portion of said rear structure;
the improvements comprising suspension means to allow for variable and controlled raising of the central portion of the vehicle frame and accordingly the center of gravity thereof upon acceleration of the vehicle, said suspension means including:
(a) means for the forward portion of the rear structure to connect to the rear portion of the front structure by at least one primary pivot point such that the front and rear structures can each pivot about its respective axle centerline and pivot with respect to each other about an axis passing horizontally through the pivot point(s) and perpendicular to the longitudinal centerline of the car; and
(b) linkage means for pivotally interconnecting one or more rear pivot point(s) on the forward portion of said rear structure with one or more forward pivot point(s) on the rear portion of said front structure, said linkage means including a plurality of links pivotally interconnecting said forward and rear pivot points, said linkage means controlling the aforesaid rotational freedom of movement of the front and rear structures, thereby
(i) preventing significant downward displacement of the mid-wheelbase portion of said vehicle, such that the desired minimum ground clearance of said vehicle is maintained under all normal operational conditions, while
(ii) permitting the mid-wheelbase portion of said vehicle frame to be upwardly displaced away from the ground, and thus the distance between said forward and rear pivot points to increase or decrease, when the vehicle is acted upon by accelerative and rotational forces transferred by the rear drive wheel(s); and
(c) one or more resilient, adjustable spring means and one or more adjustable damper means, each the spring means and damper means having one end pivotally connected, directly or through further links, to said front structure and a second end pivotally connected, directly or through further links, to said rear structure, with said spring and damper means attached so that they respectively resist and damp said accelerative and rotational forces and said tendency for the central portion of said vehicle frame to rise upon vehicle acceleration, thus
(i) limiting the maximum amount of upward displacement of said mid-wheelbase portion of the vehicle upon acceleration, and the resultant dynamic rise of vehicle center of gravity height, to an extent which may be adjusted and modified in order to optimize upward center of gravity height change and resultant rearward weight transfer for desired acceleration characteristics,
(ii) controlling the rate at which said upward displacement of said mid-wheelbase portion of the vehicle occurs upon acceleration, to an extent which may be adjusted and modified in order to optimize upward center of gravity height change and resultant rearward weight transfer for desired acceleration characteristics,
(iii) providing an adjustable and damped spring resilient force to assist the return of said mid-wheelbase portion of the vehicle to its at-rest position, and
(iv) providing an adjustable degree of damping of all of said upward or downward relative motions of said mid-wheelbase portion of the vehicle which might occur during vehicle operation.

17. The combination of claim 16 wherein said linkage means limits downward motion of said mid-wheelbase portion of said vehicle below the design minimum ground clearance by means comprising contact by one or more of the components of the linkage means or the damper means with a hard rubber or similar minimally compliant bump stop so as to prevent movement beyond the desired range of motion, to include by way of example and not limitation contact of the damper body with a rubber damper stop attached to the top of the damper actuating rod.

18. The combination of claim 16 wherein said linkage means is comprised of the damper means, such that one or more dampers are pivotally connected, directly or via further links, to said forward and said rear pivot points such that relative motion of the front structure and rear structure will cause motion of the damper means, said motion thus being adjustably damped.

19. The combination of claim 16 wherein said spring means is comprised of one or more torsion bar springs, one end of each such spring being rigidly attached to the front or rear structure, and the other end being attached, directly or via further links, to the other structure, such that the relative rotation of the front and rear structure upon the raising of the mid-wheelbase portion of the vehicle will impart torsional forces upon the spring means and be resisted accordingly.
